(19) United States
(12) Patent Application Publication
(10) Pub. No.: US 2012/0121139 A1
(43) Pub. Date: May 17, 2012

(54) INSPECTION APPARATUS, INSPECTION METHOD, AND STORAGE MEDIUM

(75) Inventors: Keiji KOJIMA, Kanagawa (JP); Hiroyoshi ISHIZAKI, Kanagawa (JP)

(73) Assignee: RICOH COMPANY, LTD., Tokyo (JP)

(21) Appl. No.: 13/277,382

(22) Filed: Oct. 20, 2011

(30) Foreign Application Priority Data
Nov. 15, 2010 (JP) 2010-254469

(51) Int. Cl. G06K 9/00

(52) U.S. Cl. 382/112

(57) ABSTRACT

An inspection apparatus includes an obtaining unit configured to receive a target image obtained by scanning a printed surface of a printed material and receive a reference image obtained from print data of the printed surface; an analysis unit configured to analyze the reference image to obtain flatness levels indicating degrees of variation in pixel values; and a control unit configured to determine inspection thresholds for different types of image areas in the reference image based on the flatness levels, compare the reference image and the target image to detect differences in pixel values, and determine whether the differences are greater than or equal to the inspection thresholds to inspect print quality of the printed surface for the respective image areas.

### CROSS-REFERENCE TO RELATED APPLICATION

The present application is based upon and claims the benefit of priority of Japanese Patent Application No. 2010-254469, filed on Nov. 15, 2010, the entire contents of which are incorporated herein by reference.

### BACKGROUND OF THE INVENTION

1. Field of the Invention

An aspect of this disclosure relates to a technology for inspecting the print quality of a printed material.

2. Description of the Related Art

In commercial printing, strict quality control is performed. For example, printed materials are strictly inspected to determine whether they are correctly printed as intended (at high quality). Since a large number of printed materials are inspected in commercial printing, visual inspection by operators or workers is inefficient and may result in inconsistent inspection results.

Japanese Laid-Open Patent Publication No. 2006-88562, for example, discloses a technology for automatically inspecting printed materials. In the disclosed technology, areas where information is printed (i.e., areas covered by toner or ink, hereafter called “printed areas”) and areas where no information is printed (i.e., areas not covered by toner or ink, hereafter called “non-printed areas”) in the printing range are identified based on prepress data. Next, the density levels (or light intensity levels) of the prepress data and those of a scanned image of a printed surface are compared for the respective printed areas and non-printed areas to determine their differences. Then, a defect determining process is performed based on the differences and predetermined thresholds to automatically inspect the print quality.

With the disclosed technology, however, it is difficult to accurately inspect the print quality of the printed areas.

Printed areas may be roughly categorized, for example, into two types: a non-flat area (e.g., a picture area or an edge area) where the degree of variation in pixel values is large and a flat area (e.g., a background area) where the degree of variation in pixel values is small. Unlike in a non-flat area, even small deviations (or changes) in pixel values in a flat area are easily noticeable to the human eye and may affect the print quality.

For this reason, in the defect determining process, it is preferable to use different thresholds for flat areas and non-flat areas. If a large threshold suitable for non-flat areas is used for flat areas, it is difficult to properly identify defects in the flat areas. Meanwhile, if a small threshold suitable for flat areas is used for non-flat areas, tolerable deviations (or changes) in pixel values in the non-flat areas may also be detected as defects.

### SUMMARY OF THE INVENTION

In an aspect of this disclosure, there is provided an inspection apparatus that includes an obtaining unit configured to receive a target image obtained by scanning a printed surface of a printed material and receive a reference image obtained from print data of the printed surface; an analysis unit configured to analyze the reference image to obtain flatness levels indicating degrees of variation in pixel values; and a control unit configured to determine inspection thresholds for different types of image areas in the reference image based on the flatness levels, compare the reference image and the target image to detect differences in pixel values, and determine whether the differences are greater than or equal to the inspection thresholds to inspect print quality of the printed surface for the respective image areas.

### BRIEF DESCRIPTION OF THE DRAWINGS

FIG. 1 is a drawing illustrating an exemplary configuration of an inspection system according to a first embodiment;

FIG. 2 is a block diagram illustrating an exemplary hardware configuration of an inspection apparatus according to the first embodiment;

FIG. 3 is a flowchart illustrating a related-art defect inspection process;

FIGS. 4A and 4B are drawings illustrating differences in pixel values in printed areas;

FIG. 5 is a block diagram illustrating an exemplary functional configuration of an inspection apparatus according to the first embodiment;

FIGS. 6A and 6B are drawings used to describe an exemplary relationship between types of image areas and flatness levels;

FIGS. 7A and 7B are drawings illustrating exemplary methods of detecting differences in pixel values according to the first embodiment;

FIG. 8 is a flowchart illustrating an exemplary defect inspection process according to the first embodiment;

FIG. 9 is a flowchart illustrating another exemplary defect inspection process according to the first embodiment;

FIG. 10 is a flowchart illustrating still another exemplary defect inspection process according to the first embodiment;

FIG. 11 is a block diagram illustrating an exemplary hardware configuration of an image processing apparatus;

FIG. 12 is a block diagram illustrating an exemplary hardware configuration of an image forming apparatus;

FIG. 13 is a block diagram illustrating an exemplary functional configuration of an inspection apparatus according to a second embodiment;

FIG. 14 is a flowchart illustrating an exemplary defect inspection process according to the second embodiment; and

FIG. 15 is a flowchart illustrating an exemplary defect determining process for a background area according to the second embodiment.

### DESCRIPTION OF THE PREFERRED EMBODIMENTS

Preferred embodiments of the present invention are described below with reference to the accompanying drawings.

### First Embodiment

### <System Configuration>

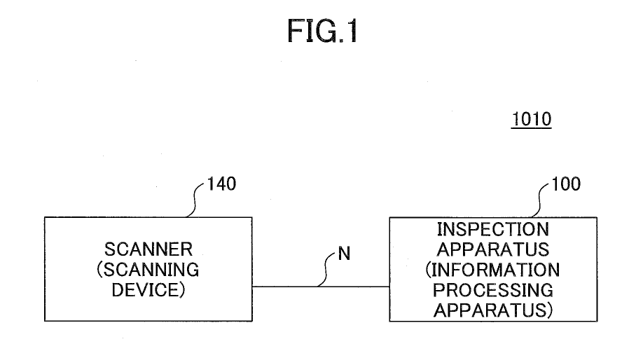

FIG. 1 is a drawing illustrating an exemplary configuration of an inspection system 1010 according to a first embodiment.

As illustrated in FIG. 1, the inspection system 1010 includes a scanner 140 and an inspection apparatus 100 that are connected to each other via a data communication channel N (e.g., a network cable or a serial/parallel cable).

The scanner 140 optically scans printed surfaces of printed materials to obtain scanned images. The inspection apparatus 100 is an information processing apparatus that inspects the print quality of printed materials.

With the above configuration, the inspection system 1010 provides the user with an inspection service for inspecting the print quality of printed materials. For example, the user inputs a reference image of a printed surface of a printed material to the inspection apparatus 100. The reference image is obtained by ripping print data of the printed material and is used for print quality inspection. Next, the user scans the printed surface of the printed material with the scanner 140 to obtain a scanned image.

Then, the scanner 140 sends the scanned image to the inspection apparatus 100. The inspection apparatus 100 compares the scanned image with the reference image to detect differences in pixel values between the scanned image and the reference image, performs a defect determining process based on the detected differences in pixel values and predetermined inspection thresholds (defect determining criteria), and outputs the results of the defect determining process (i.e., print quality inspection results) for the user.

Thus, the inspection system 1010 of the first embodiment can provide an inspection service as described above. In the inspection system 1010, plural scanners 140 may be connected to one inspection apparatus 100. This configuration makes it possible to scan multiple printed materials at once with the scanners 140 and perform multiple defect determining processes in parallel by the inspection apparatus 100. This in turn makes it possible to efficiently inspect the print quality of a large number of printed materials in, for example, commercial printing.

### <Hardware Configuration>

An exemplary hardware configuration of the inspection apparatus 100 of the first embodiment is described below.

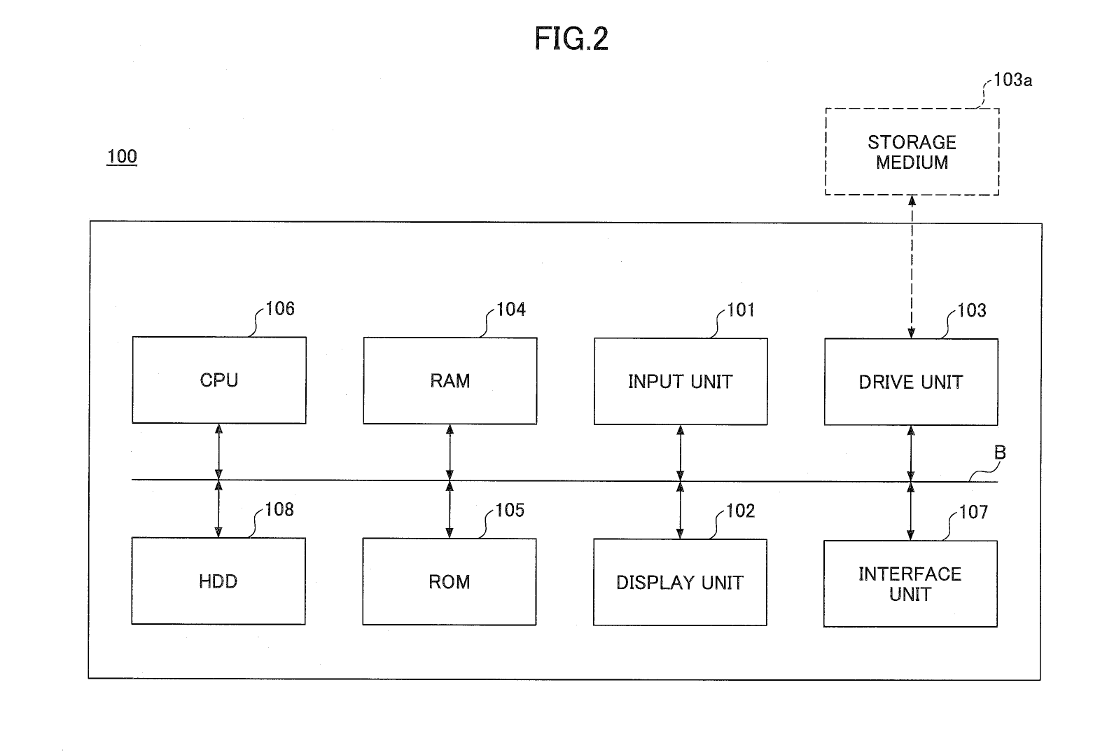

FIG. 2 is a block diagram illustrating an exemplary hardware configuration of the inspection apparatus 100.

As illustrated in FIG. 2, the inspection apparatus 100 may include an input unit 101, a display unit 102, a drive unit 103, a random access memory (RAM) 104, a read only memory (ROM) 105, a central processing unit (CPU) 106, an interface unit 107, and a hard disk drive (HDD) 108 that are connected to each other via a bus B.

The input unit 101 includes, for example, a keyboard and a mouse, and is used to input instructions (or operation signals) to the inspection apparatus 100. The display unit 102 displays, for example, processing results of the inspection apparatus 100.

The interface unit 107 connects the inspection apparatus 100 to the data communication channel N. The inspection apparatus 100 can communicate with the scanner 140 and other apparatuses having a communication function via the interface unit 107.

The HDD 108 is a non-volatile storage medium for storing various programs and data. For example, the HDD 108 stores basic software (e.g., an operating system such as Windows (trademark/registered trademark) or UNIX (trademark/registered trademark)) for controlling the entire inspection apparatus 100, and applications that run on the basic software and provide various functions (e.g., an inspection function). The HDD 108 may manage the stored programs and data using a file system and/or a database (DB).

The drive unit 103 is an interface between the inspection apparatus 100 and a removable storage medium 103a. The inspection apparatus 100 can read and write data from and to the storage medium 103a via the drive unit 103. Examples of the storage medium 103a include a floppy (flexible) disk (FD), a compact disk (CD), a digital versatile disk (DVD), a secure digital (SD) memory card, and a universal serial bus (USB) memory.

The ROM 105 is a non-volatile semiconductor memory (storage unit) that can retain data even when the power is turned off. For example, the ROM 105 stores programs and data such as a basic input/output system (BIOS) that is executed when the inspection apparatus 100 is turned on, and system and network settings of the inspection apparatus 100. The RAM 104 is a volatile semiconductor memory (storage unit) for temporarily storing programs and data. The CPU 106 loads programs and data from storage units (e.g., the HDD 108 and the ROM 105) into the RAM 104 and executes the loaded programs to control the inspection apparatus 100 and to perform various functions.

With the above hardware configuration, the inspection apparatus 100 can provide an inspection service (or an inspection function) of the first embodiment.

### <Inspection Function>

An exemplary inspection function of the inspection apparatus 100 of the first embodiment is described below.

The inspection apparatus 100 obtains a scanned image (hereafter called a target image) of a printed surface of a printed material and a reference image of the printed surface. The reference image is obtained by ripping print data of the printed material. The inspection apparatus 100 analyzes the reference image and obtains flatness levels indicating degrees of variation in pixel values in the reference image. Based on the obtained flatness levels, the inspection apparatus 100 identifies various types of image areas and determines inspection thresholds (defect determining criteria) for the respective types of image areas. Next, the inspection apparatus 100 compares pixels in the identified image areas of the reference image with pixels at the corresponding positions (in the corresponding image areas) in the target image to detect differences between their pixel values. Then, the inspection apparatus 100 determines whether the detected differences are greater than or equal to the corresponding inspection thresholds to detect defects on the printed surface. The inspection apparatus 100 of the first embodiment includes the inspection function as described above.

### <Related-Art Inspection Process>

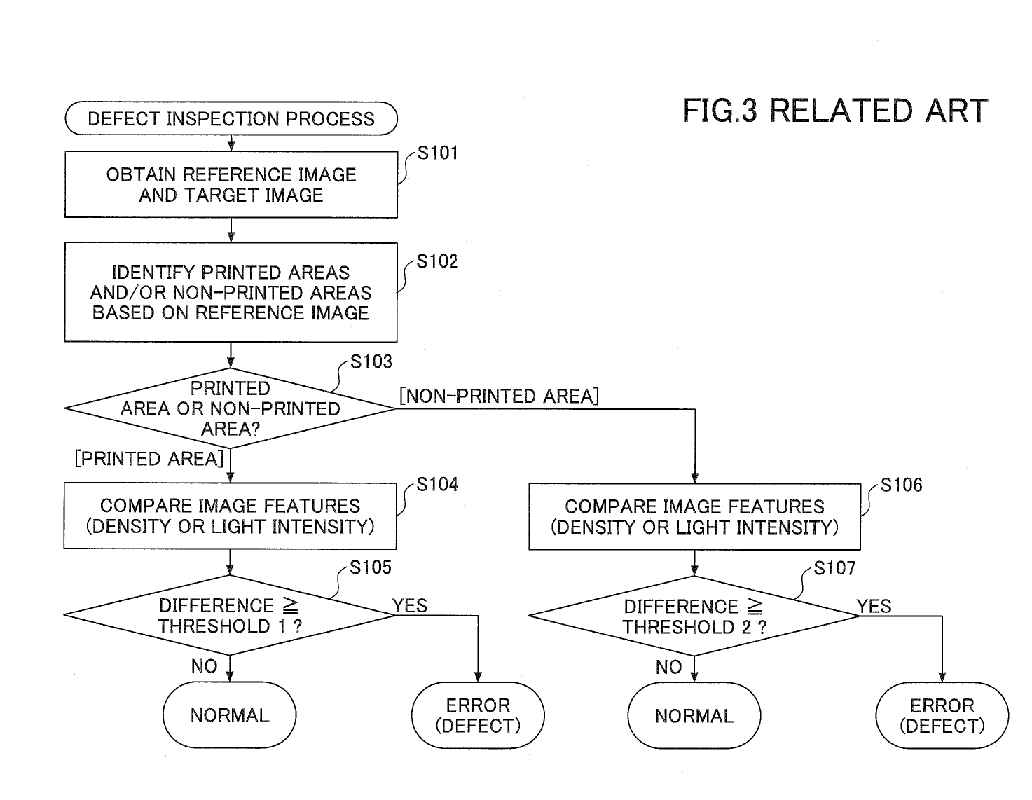

FIG. 3 is a flowchart illustrating a related-art defect inspection process.

As illustrated in FIG. 3, in the related-art defect inspection process, a reference image and a target image are obtained (step S101). Based on the reference image, printed areas and/or non-printed areas in the printing range of a printed surface of a printed material are identified (step S102).

For each of the identified areas, whether the identified area is a printed area or a non-printed area is determined (step S103).

If the identified area is a printed area, an image feature (density or light intensity) of the printed area of the reference image is compared with the image feature of the corresponding area of the target image to detect a difference in the image feature (step S104), and whether the detected difference is greater than or equal to a threshold 1 (for inspection of printed areas) is determined (step S105). If the difference is greater than or equal to the threshold 1, it is determined that there is a defect in the area of the target image.

Meanwhile, if the identified area is a non-printed area, an image feature (density or light intensity) of the non-printed area of the reference image is compared with the image feature of the corresponding area of the target image to detect a difference in the image feature (step S106), and whether the detected difference is greater than or equal to a threshold 2 (for inspection of non-printed areas) is determined (step S107). If the difference is greater than or equal to the threshold 2, it is determined that there is a defect in the area of the target image.

With the related-art method, however, it is difficult to accurately inspect the print quality of printed areas due to the reasons described below.

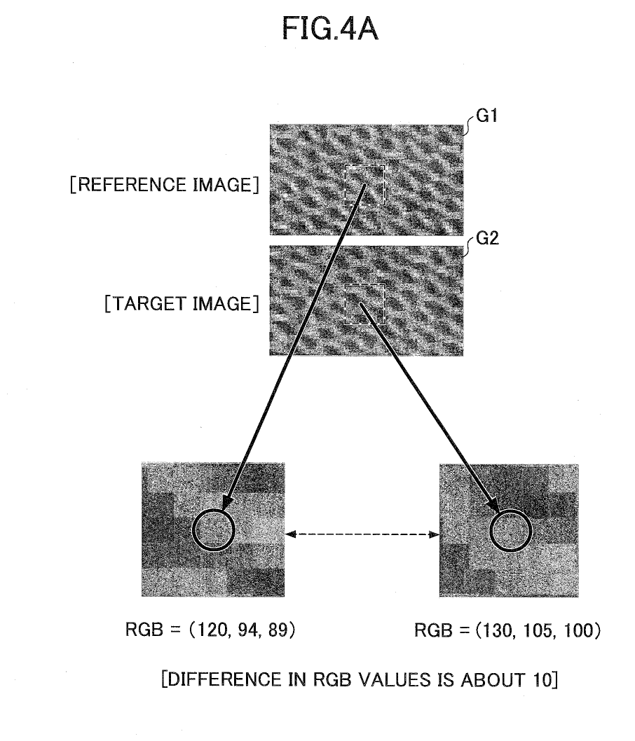

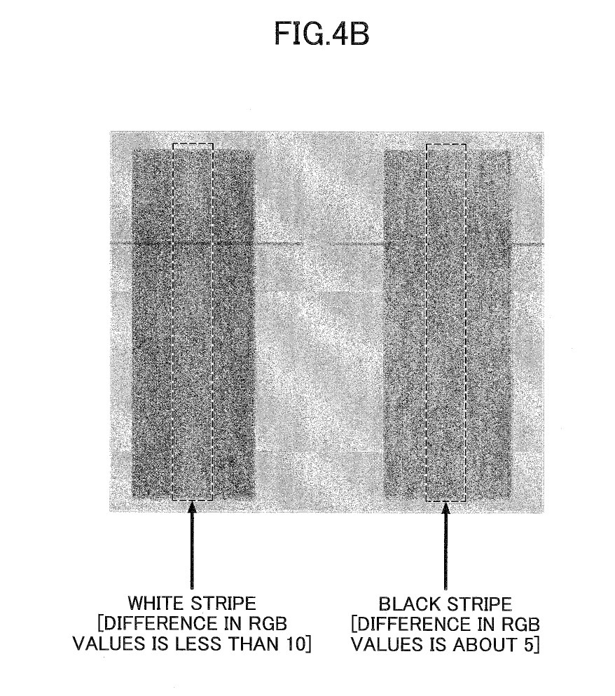

FIGS. 4A and 4B are drawings illustrating differences in pixel values in printed areas.

For example, printed areas may be roughly categorized into two types: a non-flat area (e.g., a picture area or an edge area) where the degree of variation in pixel values is large (FIG. 4A) and a flat area (e.g., a background area) where the degree of variation in pixel values is small (FIG. 4B).

In FIG. 4A, the pixel values (e.g., RGB values) of a pixel in a picture area (a non-flat area) of a reference image G1 are compared with the pixel values of a pixel at the corresponding position in a target image G2 to detect differences in the pixel values. In this example, each of the differences in the pixel values between the reference image G1 and the target image G2 is about 10.

FIG. 4B illustrates a background area (a flat area) where a white stripe and a black stripe (i.e., defects) are generated. As is apparent from FIGS. 4A and 4B, unlike in a non-flat area, even small deviations in pixel values in a flat area are easily noticeable to the human eye and may affect the print quality. In other words, the human eye is insensitive to small deviations in pixel values in a non-flat area and sensitive to small deviations in pixel values in a flat area.

In the example of FIG. 4B, the difference in pixel values between the reference image G1 and the target image G2 is less than 10 in an area corresponding to the white stripe and is about 5 in an area corresponding to the black stripe.

For the above reasons, if a large threshold suitable for non-flat areas is used for inspection of flat areas, it is difficult to properly identify defects in the flat areas. Meanwhile, if a small threshold suitable for flat areas is used for inspection of non-flat areas, tolerable deviations (or changes) in pixel values in the non-flat areas may also be detected as defects.

Accordingly, in a defect determining process, it is preferable to use different thresholds for flat areas and non-flat areas.

In the first embodiment, the inspection apparatus 100 analyzes the reference image G1 (obtained by ripping print data) to obtain flatness levels indicating degrees of variation in pixel values, identifies various types of image areas based on the obtained flatness levels, and determines inspection thresholds (defect determining criteria) used in the defect determining process for the respective types of image areas.

In other words, the inspection apparatus 100 inspects the print quality of flat areas using a defect determining criterion that is stricter than that used for the inspection of non-flat areas. This configuration makes it possible to accurately inspect the print quality of printed areas.

### <Functional Configuration and Operations>

An exemplary functional configuration and operations of the inspection apparatus 100 are described below.

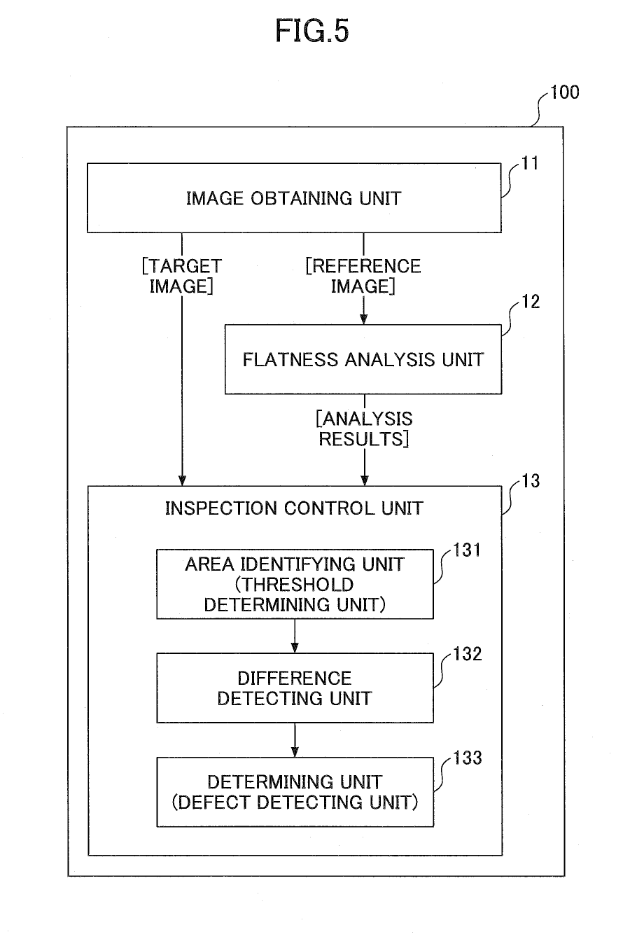

FIG. 5 is a block diagram illustrating an exemplary functional configuration of the inspection apparatus 100 according to the first embodiment.

As illustrated in FIG. 5, the inspection apparatus 100 includes an image obtaining unit 11, a flatness analysis unit 12, and an inspection control unit 13.

The image obtaining unit 11 is a functional unit that obtains the reference image G1 and the target image G2. For example, the image obtaining unit 11 receives the reference image G1 that is obtained by ripping print data and input to the inspection apparatus 100, and receives the target image G2 that is a scanned image of a printed surface from the scanner 140.

The flatness analysis unit 12 is a functional unit that analyzes the reference image G1 received from the image obtaining unit 11 and thereby obtains flatness levels indicating degrees of variation in pixel values of the reference image G1. For example, the flatness analysis unit 12 may calculate a standard deviation or a variance of pixel values (RGB values) in each rectangular area (e.g., 5×5, 7×7, or 9×9) of the reference image G1 as a direct flatness level. As another example, the flatness analysis unit 12 may calculate a total or an average of differences between pixel values (RGB values) of a reference pixel and adjacent pixels adjacent to the reference pixel in each rectangular area of the reference image G1 as a direct flatness level. The flatness analysis unit 12 may also be configured to convert or quantize the degrees of variation in pixel values (RGB values) calculated as described above into representative values indicating flatness levels.

In the first embodiment, the reference image G1 obtained by ripping print data and having stable pixel values is used to obtain the flatness levels. In the first embodiment, it is assumed that pixel values are represented by RGB values. However, pixel values may be represented by any other color space values.

Exemplary flatness analysis results are described below.

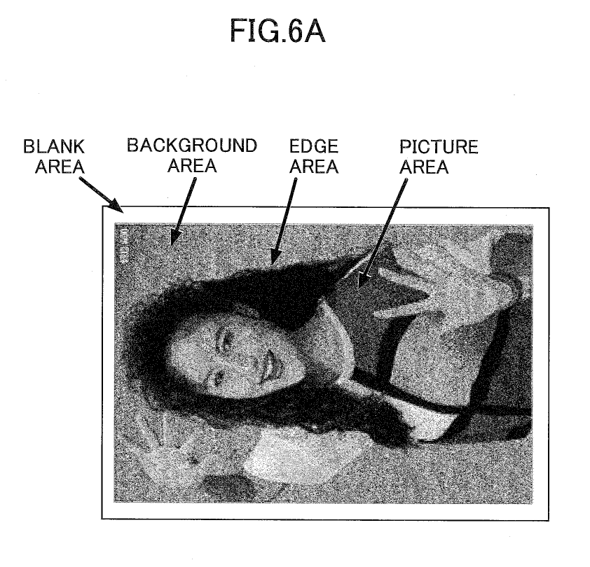

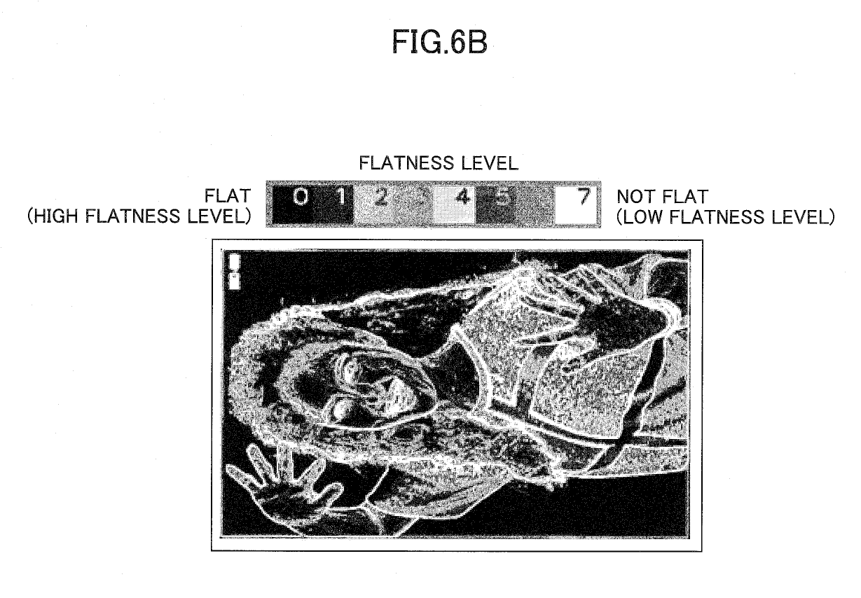

FIGS. 6A and 6B are drawings used to describe an exemplary relationship between types of image areas and flatness levels.

FIG. 6A illustrates types of image areas in the reference image G1. The reference image G1 includes printed areas and a non-printed area. The printed areas are covered by toner or ink. Meanwhile, the non-printed area is not covered by toner or ink. In the descriptions below, the non-printed area is called a blank area.

The printed areas include a background area, an edge area, and a picture area. The background area is a flat area where the degree of variation in pixel values is small. The edge area and the picture area are non-flat areas where the degree of variation in pixel values is large.

The flatness analysis unit 12 analyzes the flatness levels of the above described image areas. FIG. 6B illustrates analysis results of the reference image G1 illustrated in FIG. 6A.

In the example of FIG. 6B, the analysis results of the reference image G1 are represented by eight flatness levels. In other words, the degrees of variation in pixel values in the reference image G1 are converted by the flatness analysis unit 12 into representative values 0 through 7. In this example, the flatness level “0” is assigned to a pixel whose degree of variation in pixel values is the smallest, and the flatness level “7” is assigned to a pixel whose degree of variation in pixel values is the largest. The flatness levels “1” through “6” are assigned to pixels whose degrees of variation in pixel values are between the largest and the smallest.

Based on the eight flatness levels, the inspection apparatus 100 identifies printed areas such as a background area, an edge area, and a picture area in the reference image G1. For example, the background area where the degree of variation in pixel values is the smallest may be identified based on the flatness level “0”. The picture area where the degree of variation in pixel values is greater than that in the background area and is smaller than that in the edge area may be identified based on the flatness levels “1” through “6”. The edge area where the degree of variation in pixel values is the largest may be identified based on the flatness level “7”.

Similarly to the background area of the printed areas, the blank area may be identified based on the flatness level “0”. Also, since the blank area is a non-printed area, it may be identified based on other information such as the paper color or print data. For example, RGB values obtained by scanning blank paper with the scanner 140 may be stored in a storage area (e.g., the RAM 104) of the inspection apparatus 100 and an area in the reference image G1 corresponding to the stored RGB values may be identified as the blank area. Also, the blank area may be identified based on margin settings in print data or based on pixel values corresponding to the white color (RGB values: 255, 255, 255) in the reference image G1.

The inspection control unit 13 is a functional unit that controls the inspection process for various types of image areas based on the flatness levels. More specifically, the inspection control unit 13 controls a process of determining inspection thresholds (defect determining criteria) for different types of image areas, a process of comparing the reference image G1 and the target image G2 to detect differences in pixel values, and a process of detecting defects in a printed surface based on the detected differences and the inspection thresholds. For this purpose, the inspection control unit includes an area identifying unit (threshold determining unit) 131, a difference detecting unit 132, and a determining unit (defect detecting unit) 133.

The area identifying unit (threshold determining unit) 131 is a functional unit that identifies various types of image areas in the reference image G1 based on the analysis results (calculated flatness levels) of the flatness analysis unit 12. The area identifying unit 131 identifies, for example, a background area, an edge area, and a picture area based on the flatness levels.

Also, the area identifying unit 131 determines inspection thresholds (defect determining criteria) for the identified image areas. As described above, to accurately inspect printed areas, it is preferable to use different thresholds for flat areas (where the degree of variation in pixel values is small) and non-flat areas (where the degree of variation in pixel values is large). Therefore, the area identifying unit 131 assigns different (gradual) inspection thresholds (preset values such as 45, 30, 15, and 4) to the respective types of identified image areas. The inspection thresholds may be predetermined for the respective types of image areas. For example, the area identifying unit 131 determines inspection thresholds as described below.

For the background area (one type of printed area) where a difference in pixel values between a reference pixel and an adjacent pixel is the smallest and small deviations in pixel values need to be detected, the area identifying unit 131 determines an inspection threshold (e.g., the smallest threshold “4”) that is smaller than the inspection thresholds used for other image areas (e.g., the blank area, the picture area, and the edge area).

For the edge area (one type of printed area) where the difference in pixel values between a reference pixel and an adjacent pixel is the largest and detection of small deviations in pixel values is not necessary, the area identifying unit 131 determines an inspection threshold (e.g., the largest threshold “45”) that is greater than the inspection thresholds used for other printed areas (e.g., the background area and the picture area).

For the picture area (one type of printed area) where the difference in pixel values between a reference pixel and an adjacent pixel is greater than that in the background area and less than that in the edge area, the area identifying unit 131 determines an inspection threshold (e.g., the threshold “15”) that is between the inspection thresholds used for other printed areas (e.g., the background area and the edge area).

The non-printed area or the blank area has the highest flatness level (indicated by the smallest value) among the image areas. However, in the blank area, a smear on the paper surface is considered to be a defect. Therefore, in the blank area, a relatively large difference in pixel values between a pixel representing the smear in the target image G2 and the corresponding pixel in the reference image G1 needs to be detected. For this reason, for the blank area, the area identifying unit 131 determines an inspection threshold (e.g., the threshold “30”) that comes between the inspection threshold for the picture area and the inspection threshold for the edge area.

Thus, the inspection control unit 13 determines types of image areas (e.g., the blank area, the background area, the picture area, and the edge area) based on the flatness levels indicating degrees of variation in pixel values and uses different inspection thresholds (defect determining criteria) for the respective types of image areas. In other words, the inspection control unit 13 changes the sensitivity levels for detecting defects based on the flatness levels of image areas of the reference image G1.

The difference detecting unit 132 is a functional unit that compares the reference image G1 and the target image G2 and thereby detects differences in pixel values. The difference detecting unit 132 compares pixels in each identified image area of the reference image G1 with pixels at the corresponding positions in the target image G2 to detect differences between their pixel values. Exemplary methods of detecting differences in pixel values are described below.

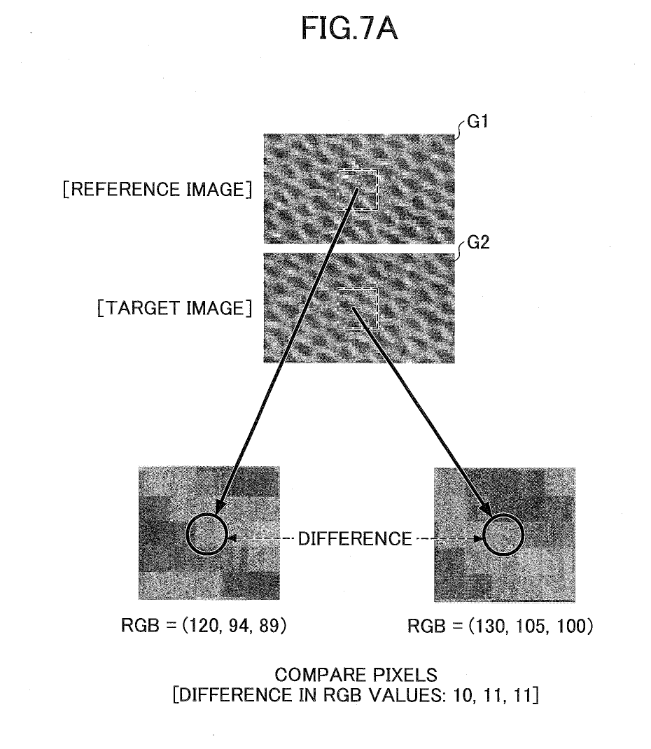

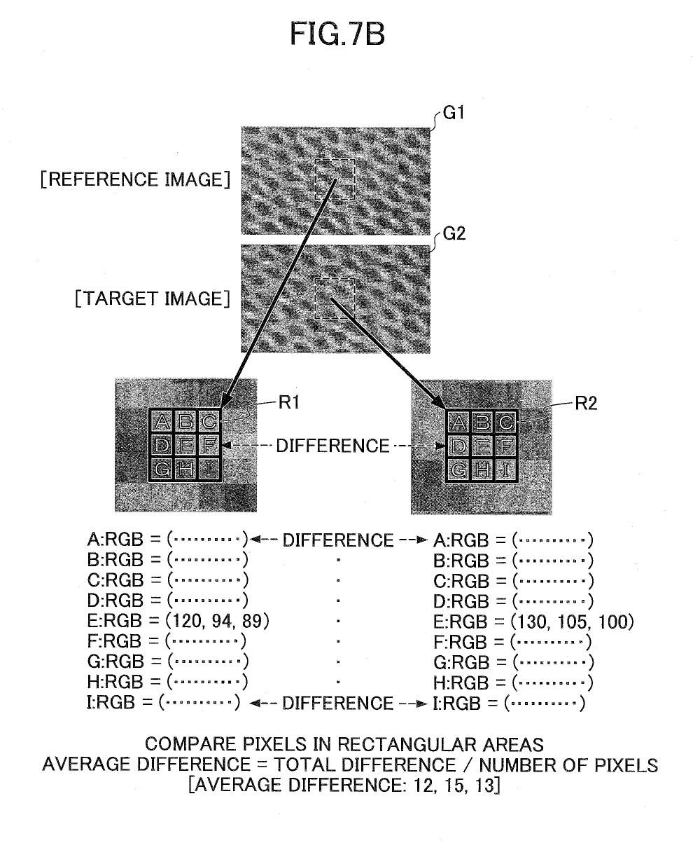

FIGS. 7A and 7B are drawings illustrating exemplary methods of detecting differences in pixel values according to the first embodiment.

FIG. 7A illustrates a first difference detection method where differences between pixels are detected, and FIG. 7B illustrates a second difference detection method where an average of differences between pixels in each rectangular area is detected.

In the first difference detection method, as illustrated in FIG. 7A, pixel values (RGB values) of each pixel in the reference image G1 are compared with pixel values of the corresponding pixel in the target image G2 to obtain absolute values indicating the differences in pixel values (for the respective RGB components) between the pixels.

In the second difference detection method, as illustrated in FIG. 7B, pixel values (RGB values) of pixels in a rectangular area R1 of the reference image G1 are compared with pixel values of pixels in a corresponding rectangular area R2 (the rectangular areas R1 and R2 may be called a rectangular area(s) R when distinction is not necessary) of the target image G2 to obtain absolute values indicating the differences between the pixel values (for the respective RGB components). In the example of FIG. 7B, pixels A through I in the rectangular area R1 of 3×3 pixels (i.e., 9 pixels) are compared with pixels A through I in the rectangular area R2 of 3×3 pixels to calculate nine sets of differences. Next, the nine sets of differences (absolute values) are totaled to obtain total differences (for the respective RGB components), and the respective total differences are divided by the number of pixels (in this example, “9”) in the rectangular area R to obtain average differences in pixel values in the rectangular area R.

The size (filter size) of the rectangular area R may be determined depending on the type of defects to be detected. For example, to detect white or black stripes generated in the background area, the size of the rectangular area R may be set at 3×3, 3×7, or 7×3 depending on the characteristics of the white or black stripes. Thus, according to the first embodiment, the size of the rectangular area R used in the second difference detection method may be determined for each of identified image areas.

The inspection control unit 13 detects differences in pixel values between the reference image G1 and the target image G2 according to the difference detection methods as described above.

The determining unit (defect detecting unit) 133 is a functional unit that performs a defect determining process. The determining unit 133 determines whether the differences detected by the difference detecting unit 132 are greater than or equal to the inspection thresholds determined for the respective types of image areas by the area identifying unit 131 and based on the results, determines whether defects are present on the printed surface. For example, when the differences in an image area are greater than or equal to the corresponding inspection threshold, the determining unit 133 determines that there is a defect (or an error) in the image area of the target image G2.

Thus, the inspection control unit 13 performs the defect determining process for each of the identified image areas and thereby inspects the printed surface.

As described above, in the inspection apparatus 100, the inspection function of the first embodiment is provided through collaboration among the above described functional units. The functional units are implemented by executing software programs installed in the inspection apparatus 100. For example, the software programs are loaded by a processing unit (e.g., the CPU 106) from storage units (e.g., the HDD 108 and/or the ROM 105) into a memory (e.g., the RAM 104) and are executed to implement the functional units of the inspection apparatus 100.

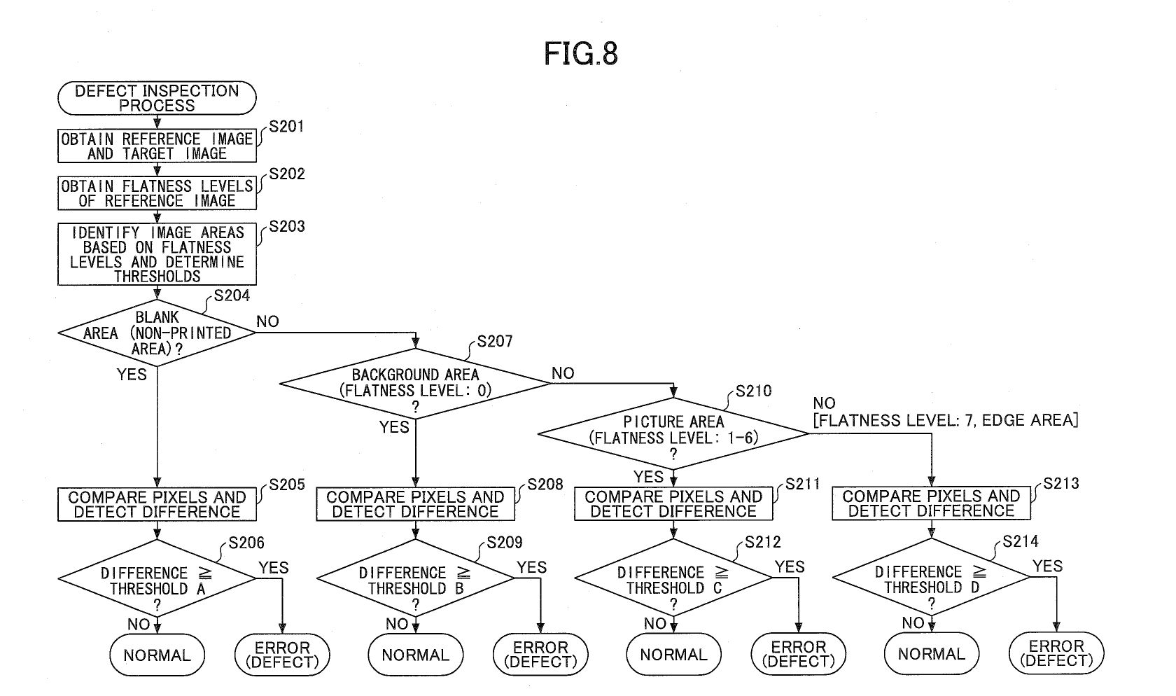

Exemplary processes performed by the functional units of the inspection apparatus 100 (collaboration among the functional units) are described below with reference to FIGS. 8 through 10.

### <Inspection Process (1)>

FIG. 8 is a flowchart illustrating an exemplary defect inspection process according to the first embodiment.

As illustrated in FIG. 8, the image obtaining unit 11 of the inspection apparatus 100 obtains the reference image G1 and the target image G2 (step S201). In this step, the image obtaining unit 11 receives the reference image G1 input to the inspection apparatus 100 and receives the target image G2 from the scanner 140.

Next, the flatness analysis unit 12 analyzes the reference image G1 to obtain flatness levels of the reference image G1 (step S202). For example, the flatness analysis unit 12 receives the reference image G1 from the image obtaining unit 11 and obtains direct flatness levels by calculating a standard deviation or a variance of pixel values (RGB values) in each rectangular area R of the reference image G1 or by calculating a total or an average of differences between pixel values (RGB values) of a reference pixel and adjacent pixels adjacent to the reference pixel in each rectangular area R of the reference image G1.

Next, the inspection control unit 13 controls the inspection process for respective types of image areas based on the flatness levels.

The area identifying unit 131 of the inspection control unit 13 identifies printed areas and a non-printed area in the reference image G1 based on the flatness levels received from the flatness analysis unit (step S203). For example, the area identifying unit 131 identifies a blank area based on the paper color or print data, and identifies a background area, a picture area, and an edge area based on the flatness levels. In this exemplary process, it is assumed that eight flatness levels (a higher flatness level indicates lower flatness) are provided, the flatness level “0” corresponds to the background area, the flatness level “1” through “6” correspond to the picture area, and the flatness level “7” corresponds to the edge area.

Also, the area identifying unit 131 assigns predetermined (gradual) inspection thresholds (preset values) A through D (D>A>C>B) to the respective types of image areas. In this exemplary process, the largest threshold D is assigned to the edge area, the smallest threshold B is assigned to the background area, the threshold A that is greater than the threshold C and smaller than the threshold D is assigned to the blank area, and the threshold C that is greater than the threshold B and smaller than the threshold A is assigned to the picture area.

Then, the difference detecting unit 132 of the inspection control unit 13 performs a defect determining process for each type of image area identified by the area identifying unit 131.

### (a) Process for Blank Area

When an area identified by the area identifying unit 131 is the blank area (YES in step S204), the difference detecting unit 132 compares pixels of the reference image G1 and the target image G2 according to the first difference detection method described above to detect differences in pixel values (step S205). In this step, the difference detecting unit 132 compares pixel values (RGB values) of each pixel in the reference image G1 with pixel values of the corresponding pixel in the target image G2 to obtain absolute values indicating the differences between the pixel values (for the respective RGB components).

Next, the determining unit 133 of the inspection control unit 13 determines whether the differences detected by the difference detecting unit 132 are greater than or equal to the threshold A assigned to the blank area (the defect determining criterion for the blank area) (step S206). If the differences are greater than or equal to the threshold A (YES in step S206), the determining unit 133 determines that there is a defect (or an error) in the blank area of the target image G2.

Although the blank area (or the non-image area) has the highest flatness level (indicated by the smallest value) among the image areas, it is not necessary to detect small deviations in pixel values in the blank area. Therefore, the inspection control unit 13 performs the defect determining process for the blank area using the threshold A that is between the thresholds D and C assigned to the edge area and the picture area.

### (b) Process for Background Area

When an area identified by the area identifying unit 131 is not the blank area (NO in step S204) but is the background area (YES in step S207), the difference detecting unit 132 compares pixels of the reference image G1 and the target image G2 according to the first difference detection method described above to detect differences in pixel values (step S208).

Next, the determining unit 133 determines whether the differences detected by the difference detecting unit 132 are greater than or equal to the threshold B assigned to the background area (the defect determining criterion for the background area) (step S209). If the differences are greater than or equal to the threshold B (YES in step S209), the determining unit 133 determines that there is a defect (or an error) in the background area of the target image G2.

Since it is necessary to detect even small deviations in pixel values in the background area, the inspection control unit 13 performs the defect determining process for the background area using the threshold B that is the smallest threshold among the thresholds assigned to the image areas.

### (c) Process for Picture Area

When an area identified by the area identifying unit 131 is not the background area (NO in step S207) but is the picture area (YES in step S210), the difference detecting unit 132 compares pixels of the reference image G1 and the target image G2 according to the first difference detection method described above to detect differences in pixel values (step S211).

Next, the determining unit 133 determines whether the differences detected by the difference detecting unit 132 are greater than or equal to the threshold C assigned to the picture area (the defect determining criterion for the picture area) (step S212). If the differences are greater than or equal to the threshold C (YES in step S212), the determining unit 133 determines that there is a defect (or an error) in the picture area of the target image G2.

Since the degree of variation in pixel values in the picture area is greater than that in the background area and less than that in the edge area, the inspection control unit 13 performs the defect determining process for the picture area using the threshold C that is between the thresholds A and B assigned to the blank area and the background area.

### (d) Process for Edge Area

When an area identified by the area identifying unit 131 is not the picture area but is the edge area (NO in step S210), the difference detecting unit 132 compares pixels of the reference image G1 and the target image G2 according to the first difference detection method described above to detect differences in pixel values (step S213).

Next, the determining unit 133 determines whether the differences detected by the difference detecting unit 132 are greater than or equal to the threshold D assigned to the edge area (the defect determining criterion for the edge area) (step S214). If the differences are greater than or equal to the threshold D (YES in step S214), the determining unit 133 determines that there is a defect (or an error) in the edge area of the target image G2.

Since it is not necessary to detect small deviations in pixel values in the edge area, the inspection control unit 13 performs the defect determining process for the edge area using the threshold D that is the largest threshold among the thresholds assigned to the image areas.

As described above, the inspection apparatus 100 of the first embodiment analyzes the reference image G1 to obtain flatness levels indicating degrees of variation in pixel values, identifies various types of image areas based on the obtained flatness levels, and determines inspection thresholds (defect determining criteria) used in the defect determining process for the respective types of image areas. This configuration makes it possible to prevent excessive defect detection (detection error) in a non-flat area where the degree of variation in pixel values is large and to strictly detect defects in a flat area where the degree of variation in pixel values is small.

In the exemplary defect inspection process, the second difference detection method may be used instead of the first difference detection method.

In this case, in steps S205, S208, S211, and S213, the difference detecting unit 132 compares pixels in the corresponding rectangular areas R of the reference image G1 and the target image G2 and calculates average differences between the pixels. More specifically, the difference detecting unit 132 compares pixel values (RGB values) of pixels in a rectangular area R of the reference image G1 with pixel values of pixels in the corresponding rectangular area R of the target image G2 to obtain absolute values indicating the differences between the pixel values (for the respective RGB components). Next, the difference detecting unit 132 totals the differences to obtain total differences for the respective RGB components, and divides the respective total differences by the number of pixels in the rectangular area R to obtain average differences between the pixels.

Then, in steps S206, S208, S212, and S214, the determining unit 133 detects defects based on the average differences and the inspection thresholds (defect determining criteria).

### <Inspection Process (2)>

Among the first and second difference detection methods of the difference detecting unit 132, the second difference detection method makes it possible to more accurately detect differences. Similarly to using different inspection thresholds for different types of image areas, the difference detection unit 132 may be configured to use one of the first and second difference detection methods depending on the type of image area.

For example, the difference detection unit 132 may be configured to use the first difference detection method for the picture area and the edge area and to use the second difference detection method for the background area to more accurately detect differences in pixel values. In other words, the difference detection unit 132 may be configured to operate according to one of the first and second difference detection methods depending on the type of image area (or depending on whether the flatness level of the image area is higher than a predetermined level).

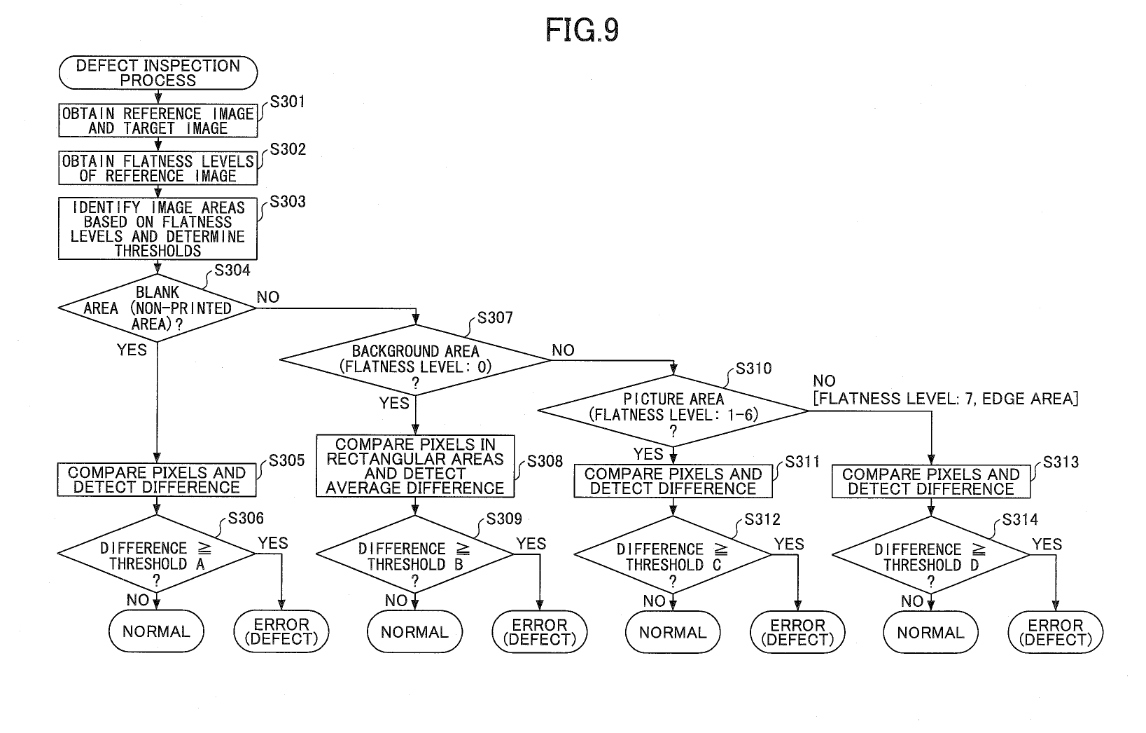

An exemplary defect inspection process where one of the first and second difference detection methods is used depending on the type of image area is described below with reference to FIG. 9.

Below, steps S305, S308, S311, and S313 of FIG. 9 that are different from the corresponding steps in FIG. 8 are mainly described.

### (a) Process for Blank Area

When an area identified by the area identifying unit 131 is the blank area (YES in step S304), the difference detecting unit 132 compares pixels of the reference image G1 and the target image G2 according to the first difference detection method to detect differences in pixel values (step S305).

That is, since it is not necessary to detect small deviations in pixel values in the blank area, the inspection control unit 13 detects differences in pixel values using the first difference detection method that is less accurate than the second difference detection method.

### (b) Process for Background Area

When an area identified by the area identifying unit 131 is not the blank area (NO in step S304) but is the background area (YES in step S307), the difference detecting unit 132 compares pixels in the corresponding rectangular areas R of the reference image G1 and the target image G2 according to the second difference detection method to detect average differences in pixel values (step S308).

That is, since it is necessary to detect even small deviations in pixel values in the background area, the inspection control unit 13 detects differences in pixel values using the second difference detection method that is more accurate than the first difference detection method.

### (c) Process for Picture Area

When an area identified by the area identifying unit 131 is not the background area (NO in step S307) but is the picture area (YES in step S310), the difference detecting unit 132 compares pixels of the reference image G1 and the target image G2 according to the first difference detection method to detect differences in pixel values (step S311).

That is, since it is not necessary to detect small deviations in pixel values in the picture area, the inspection control unit 13 detects differences in pixel values using the first difference detection method that is less accurate than the second difference detection method.

### (d) Process for Edge Area

When an area identified by the area identifying unit 131 is not the picture area but is the edge area (NO in step S310), the difference detecting unit 132 compares pixels of the reference image G1 and the target image G2 according to the first difference detection method to detect differences in pixel values (step S313).

That is, since it is not necessary to detect small deviations in pixel values in the edge area, the inspection control unit 13 detects differences in pixel values using the first difference detection method that is less accurate than the second difference detection method.

As described above, the inspection apparatus 100 may be configured to use different inspection thresholds (defect determining criteria) and different difference detection methods depending on the types (or flatness levels) of image areas. This configuration makes it possible to accurately inspect the print quality of image areas.

### <Inspection Process (3)>

The inspection apparatus 100 may include a function (hereafter called a defect-type determining function) for determining the type of a detected defect. The defect-type determining function may be provided by the determining unit 133 or by a separate functional unit of the inspection apparatus 100 (i.e., a defect-type determining unit). The defect-type determining function determines the type of a defect based on difference data of an image area. The defect-type determining function may use different methods depending on the types of defects to be determined. Therefore, in the descriptions below, it is assumed that a white/black stripe generated in the background area is to be determined.

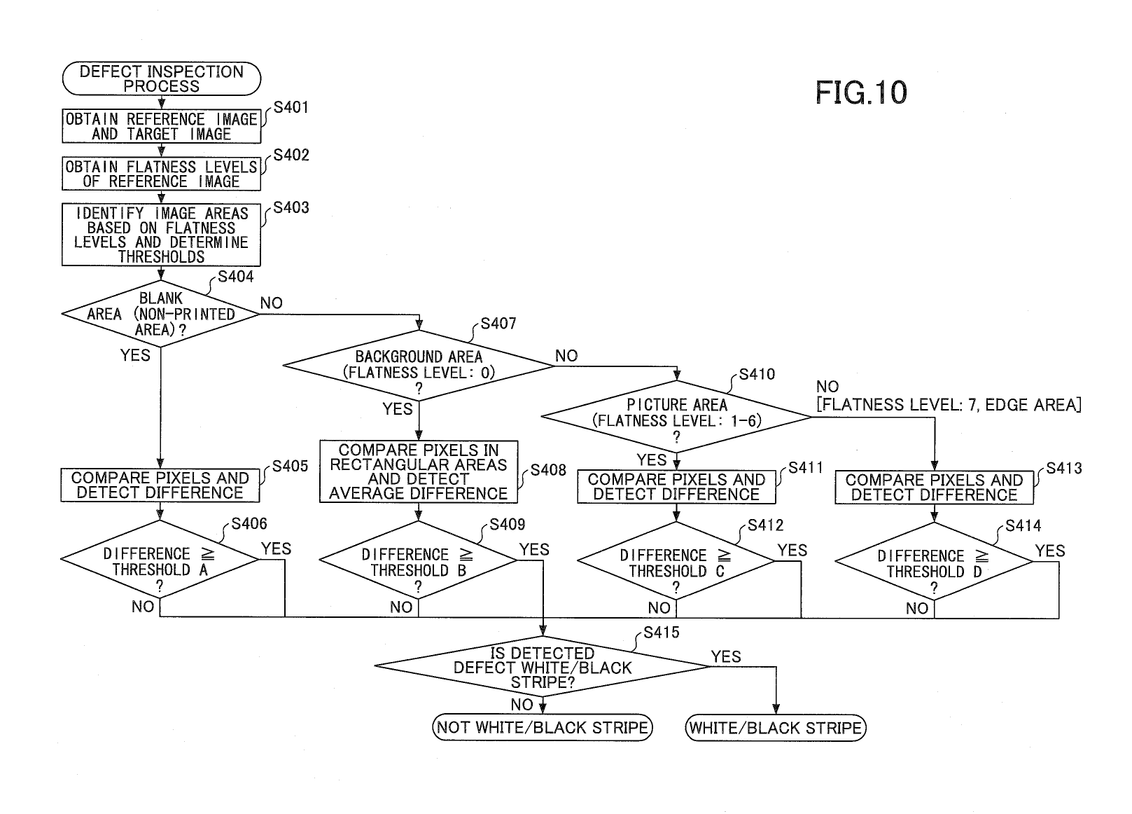

FIG. 10 is a flowchart illustrating an exemplary defect inspection process where the type of a defect is also determined. Below, step S415 of FIG. 10 that is added to the defect inspection process of FIG. 9 is mainly described.

As illustrated in FIG. 10, after a difference detecting step (S405/S408/S411/S413) and a defect determining step (S406/S409/S412/S414) are performed on an image area, the inspection apparatus 100 determines whether a detected defect is a white/black stripe based on difference data of the image area (step S415). Step S415 is described in more detail below.

The inspection apparatus 100 performs a labeling process on the target image G2 based on difference data (differences greater than or equal to the corresponding inspection threshold) of the image area. Here, the labeling process indicates a process of attaching the same label to connected pixels (e.g., a group of eight pixels) and thereby dividing the target image G2 into multiple image areas (or groups). Through the labeling process, the inspection apparatus 100 identifies a circumscribing rectangular image area corresponding to the detected defect in the target image G2.

Next, the inspection apparatus 100 determines whether the width, the length, and the aspect ratio of the identified circumscribing rectangular image area are greater than or equal to thresholds (defect-type determining criteria) indicating the predetermined width, length, and aspect ratio. The thresholds (defect-type determining criteria) may be determined for each type of defect to be determined.

When the width, the length, and the aspect ratio of the identified circumscribing rectangular image area are greater than or equal to the thresholds (YES in step S415), the inspection apparatus 100 determines that the detected defect in the target image G2 is a white/black stripe.

Here, if multiple circumscribing rectangular image areas are identified in the labeling process, the inspection apparatus 100 may be configured to calculate an adjacent distance between the circumscribing rectangular image areas based on the coordinates (in the coordinate space of the target image G2) of pixels constituting the circumscribing rectangular image areas, and to combine the circumscribing rectangular image areas if the adjacent distance is less than a predetermined adjacent distance threshold. In this case, the inspection apparatus 100 may be configured to determine the density of defects based on the width(s), the length(s), and the number of the combined circumscribing rectangular image areas and to determine the type of the defect based on the determined density.

### <Variations>

Variations of the first embodiment are described below.

### [First Variation]

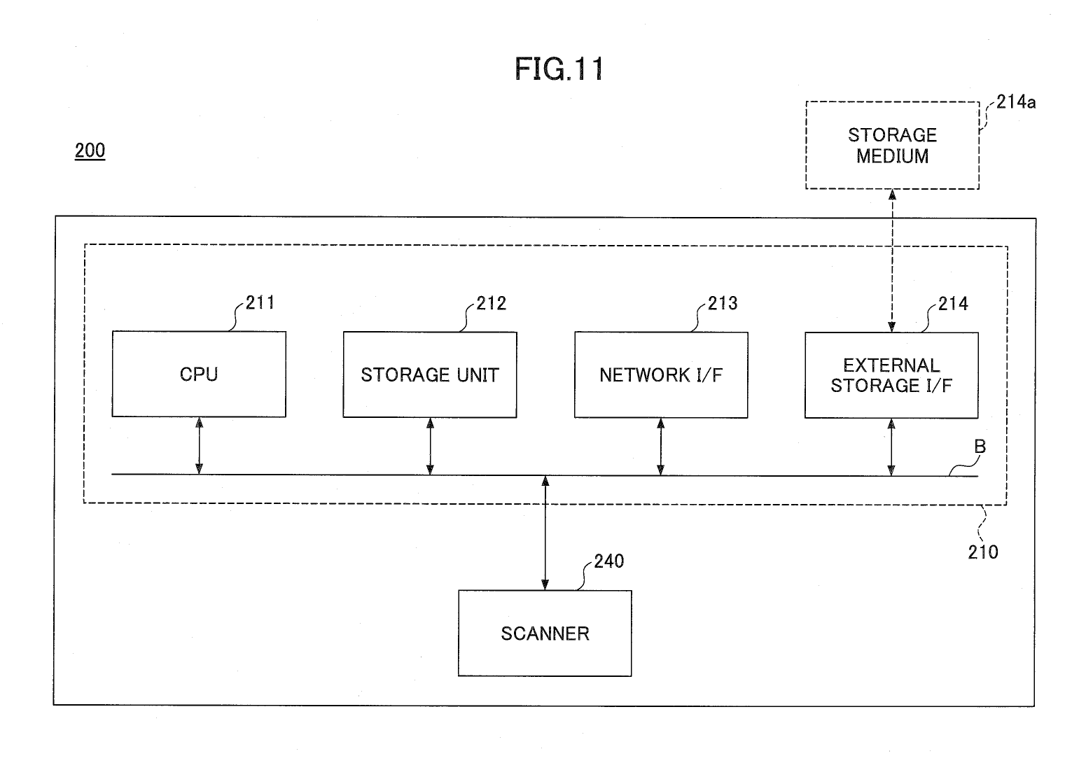

In the first embodiment, the inspection apparatus 100 is used as an example of an apparatus that provides the inspection function. However, the first embodiment may be applied to any other type of apparatus. For example, the first embodiment may be applied to an image processing apparatus 200 as illustrated in FIG. 11.

FIG. 11 is a block diagram illustrating an exemplary hardware configuration of the image processing apparatus 200 that provides the inspection function.

As illustrated in FIG. 11, the image processing apparatus 200 may include a controller 210 and a scanner 240 that are connected to each other via a bus B.

The scanner 240 optically scans a printed material or a document and generates image data (a scanned image). The controller 210 is a control circuit board including a CPU 211, a storage unit 212, a network I/F 213, and an external storage I/F 214 that are connected via the bus B.

The storage unit 212 includes a RAM, a ROM, and an HDD for storing various programs and data. The CPU 211 loads programs and data from the ROM and/or the HDD into the RAM and executes the loaded programs to control the image processing apparatus 200 and thereby implement various functions. For example, the inspection function of the first embodiment may be implemented by loading a program into the RAM and executing the loaded program by the CPU 211.

The network I/F 213 is an interface for connecting the image processing apparatus 200 to a data communication channel. The image processing apparatus 200 can communicate with other apparatuses having communication functions via the network I/F 213. The external storage I/F 214 is an interface between the image processing apparatus 200 and a storage medium 214a used as an external storage. Examples of the storage medium 214a include an SD memory card, a USB memory, a CD, and a DVD. The image processing apparatus 200 can read and write data from and to the storage medium 214a via the external storage I/F 214.

With the above hardware configuration, the image processing apparatus 200 can single-handedly provide an inspection service for inspecting the print quality of printed materials.

### [Second Variation]

The first embodiment may also be applied to an image forming apparatus such as a multifunction peripheral (MFP).

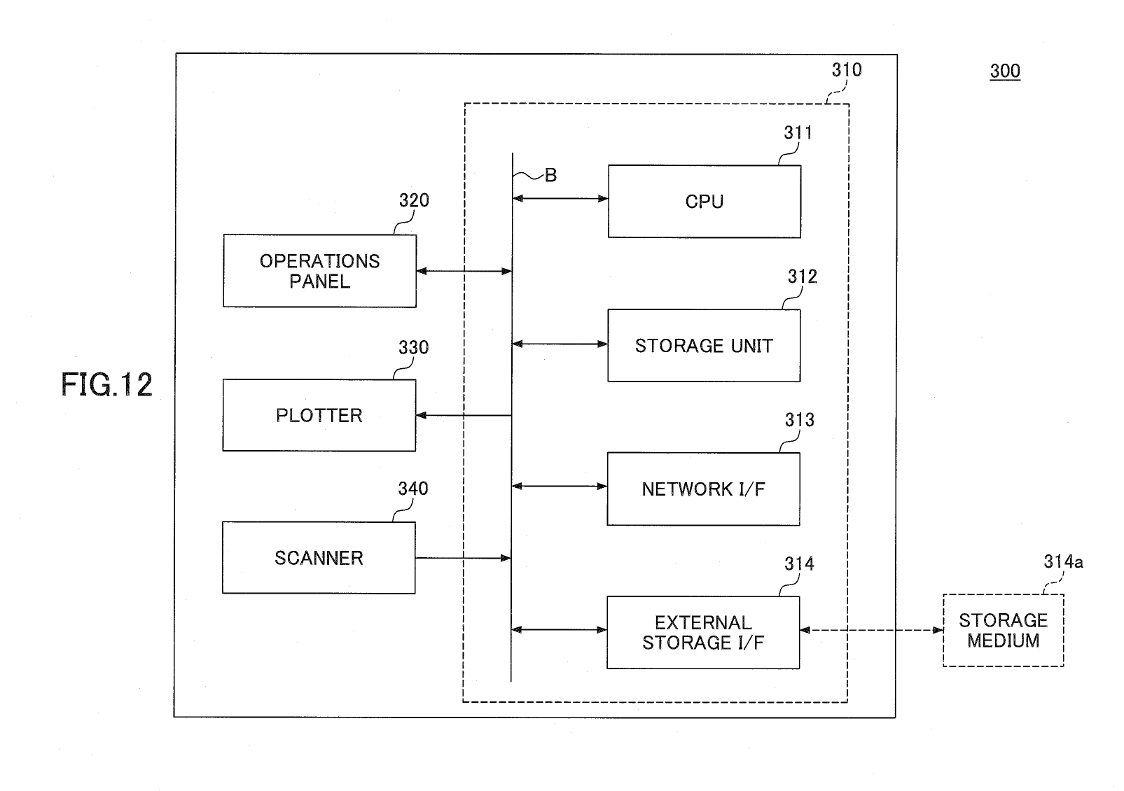

FIG. 12 is a block diagram illustrating an exemplary hardware configuration of an image forming apparatus 300 that provides the inspection function.

As illustrated in FIG. 12, the image forming apparatus 300 may include a controller 310, an operations panel 320, a plotter 330, and a scanner 340 that are connected to each other via a bus B.

The operations panel 320 includes a display unit for providing information such as device information to the user and an input unit for receiving user inputs such as settings and instructions. The plotter 330 includes an image forming unit for forming an image on a recording medium (e.g., paper). For example, the plotter 330 forms an image by electrophotography or inkjet printing.

The controller 310 is a control circuit board including a CPU 311, a storage unit 312, a network I/F 313, and an external storage I/F 314 that are connected via the bus B.

The storage unit 312 includes a RAM, a ROM, and an HDD for storing various programs and data. The CPU 311 loads programs and data from the ROM and/or the HDD into the RAM and executes the loaded programs to control the image forming apparatus 300 and thereby implement various functions. For example, the inspection function of the first embodiment may be implemented by loading a program into the RAM and executing the loaded program by the CPU 311.

The network I/F 313 is an interface for connecting the image forming apparatus 300 to a data communication channel. The image forming apparatus 300 can communicate with other apparatuses having communication functions via the network I/F 313. The external storage I/F 314 is an interface between the image forming apparatus 200 and a storage medium 314a used as an external storage. Examples of the storage medium 314a include an SD memory card, a USB memory, a CD, and a DVD. The image forming apparatus 300 can read and write data from and to the storage medium 314a via the external storage I/F 314.

With the above hardware configuration, the image forming apparatus 300 can single-handedly provide an inspection service for inspecting the print quality of printed materials.

In the inspection system 1010 of the first embodiment, the scanner 140 and the inspection apparatus 100 are connected to each other. However, the configuration of the inspection system 1010 is not limited to that described above. For example, the inspection system 1010 may include the inspection apparatus 100 and the image processing apparatus 200 or the image forming apparatus 300 that are connected to each other. In this case, the target image G2 is sent from the image processing apparatus 200 or the image forming apparatus 300 to the inspection apparatus 100.

### <Summary>

As described above, the image obtaining unit 11 of the inspection apparatus 100 obtains the reference image G1 and the target image G2. Next, the flatness analysis unit 12 analyzes the reference image G1 and thereby obtains flatness levels indicating degrees of variation in pixel values in the reference image G1.

Based on the obtained flatness levels, the inspection control unit 13 identifies various types of image areas in the reference image G1 and determines inspection thresholds (defect determining criteria) for the respective types of image areas. Next, the inspection control unit 13 compares pixels in each identified image area of the reference image G1 with pixels at the corresponding positions in the target image G2 to detect differences between their pixel values. Then, the inspection control unit 13 determines whether the detected differences are greater than or equal to the corresponding inspection thresholds to detect defects on the printed surface.

Thus, the inspection apparatus 100 of the first embodiment inspects the print quality of flat areas using a defect determining criterion that is stricter (or more sensitive) than that used for the inspection of non-flat areas. This configuration makes it possible to accurately inspect the print quality of image areas.

### Second Embodiment

A second embodiment is different from the first embodiment in that when the background area is identified, an inspection threshold (defect determining criterion) used to detect a defect in the background area is determined based on a flatness level obtained by analyzing the target image G2.

In the second embodiment, descriptions overlapping those in the first embodiment are omitted, and the same reference numbers as those used in the first embodiment are assigned to the corresponding components.

### <Inspection Function>

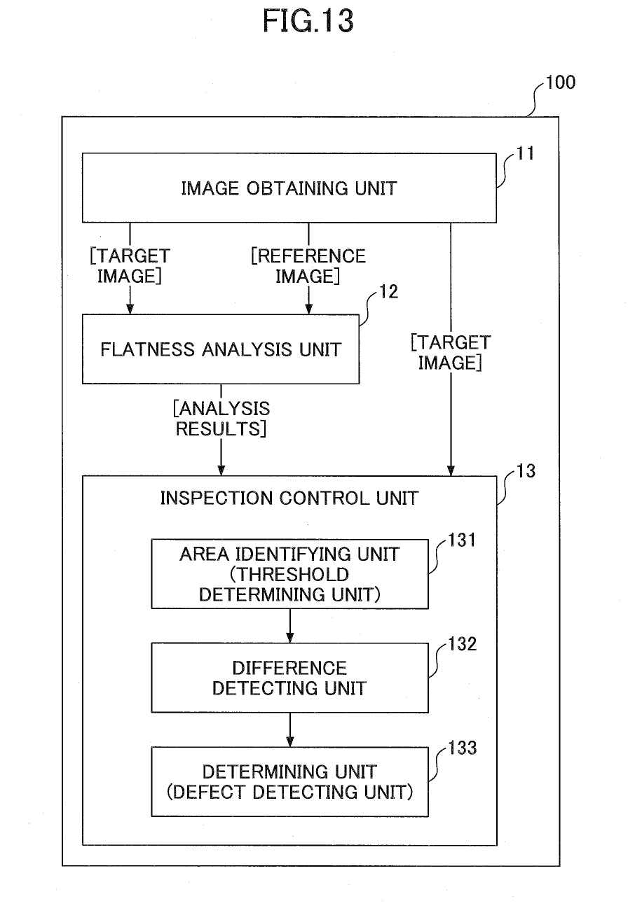

FIG. 13 is a block diagram illustrating an exemplary functional configuration of the inspection apparatus 100 according to the second embodiment.

As illustrated in FIG. 13, the flatness analysis unit 12 also analyzes the target image G2 in addition to the reference image G1 and thereby obtains flatness levels indicating degrees of variation in pixel values in the target image G2. The method(s) used to analyze the reference image G1 in the first embodiment may be used to analyze the target image G2. Accordingly, in the second embodiment, the flatness analysis unit 12 analyzes the reference image G1 and the target image G2 and thereby obtains two sets of flatness levels for the reference image G1 and the target image G2.

Based on the obtained flatness levels for the reference image G1, the area identifying unit 131 identifies various types of image areas in the reference image G1 and determines inspection thresholds (defect determining criteria) for the respective types of image areas.

When the background area is identified in the reference image G1, the area identifying unit 131 determines an inspection threshold (defect determining criterion) for the background area as described below.

The area identifying unit 131 refers to a flatness level(s) (in the obtained flatness levels) of an image area of the target image G2 that is located at a position corresponding to the identified background area of the reference image G1. Here, it is assumed that coordinate spaces of the reference image G1 and the target image G2 are matched when they are analyzed by the flatness analysis unit 12.

Based on the flatness level, the area identifying unit 131 determines whether the corresponding image area of the target image G2 is flat. For example, the area identifying unit 131 determines whether the flatness level of the corresponding image area of the target image G2 is greater than or equal to a predetermined flatness threshold (e.g, “2”).

If the image area of the target image G2 corresponding to the background area of the reference image G2 is not flat, it is assumed that a defect is present in the image area.

Therefore, if the flatness level of the image area of the target image G2 is greater than or equal to the flatness threshold, the area identifying unit 131 assumes that there is a defect in the image area of the target image G2 and determines a first inspection threshold (defect determining criterion) (e.g., “4”) that enables detecting small deviations in pixel values for the background area (or the image area corresponding to the background area).

Meanwhile, if the flatness level of the image area of the target image G2 is less than the flatness threshold, the area identifying unit 131 assumes that there is no defect in the image area of the target image G2 and determines a second inspection threshold (defect determining criterion) (e.g., “10”) that is greater than the first inspection threshold for the background area (or the image area corresponding to the background area).

Also, the inspection control unit 13 performs the difference detecting step and the defect determining step at different accuracy levels in a case where the image area of the target image G2 is flat and a case where the image area of the target image G2 is not flat.

When the flatness level of the image area of the target image G2 is greater than or equal to the flatness threshold (when a defect is assumed to be present), the difference detecting unit 132 detects average differences between pixels in rectangular areas R of the reference image G1 and the target image G2 according to the second difference detection method described in the first embodiment. Then, the determining unit 133 determines whether the detected differences are greater than or equal to the first inspection threshold to detect a defect in the background area. In detecting the average differences, the size of the rectangular areas R may be set at 3×7 or 7×3 used to detect a white/black stripe in the background area.

Meanwhile, when the flatness level of the image area of the target image G2 is less than the flatness threshold (when no defect is assumed to be present), the difference detecting unit 132 detects differences between pixels in the reference image G1 and the target image G2 according to the first difference detection method described in the first embodiment. Then, the determining unit 133 determines whether the detected differences are greater than or equal to the second inspection threshold to detect a defect in the background area.

Thus, in the second embodiment, the inspection apparatus 100 determines the probability that a defect is present in a flat area based on a flatness level obtained by analyzing the target image G2 and if it is probable that a defect is present, inspects the print quality of the flat area using a strict (or sensitive) defect determining criterion. This configuration makes it possible to efficiently and accurately inspect the print quality of image areas.

As described above, in the inspection apparatus 100, the inspection function of the second embodiment is provided through collaboration among the functional units. The functional units are implemented by executing software programs installed in the inspection apparatus 100. For example, the software programs are loaded by a processing unit (e.g., the CPU 106) from storage units (e.g., the HDD 108 and/or the ROM 105) into a memory (e.g., the RAM 104) and are executed to implement the functional units of the inspection apparatus 100. The second embodiment may also be applied to the image processing apparatus 200 of FIG. 11 and the image forming apparatus 300 of FIG. 12.

An exemplary inspection process according to the second embodiment is described below with reference to a flowchart.

### <Inspection Process>

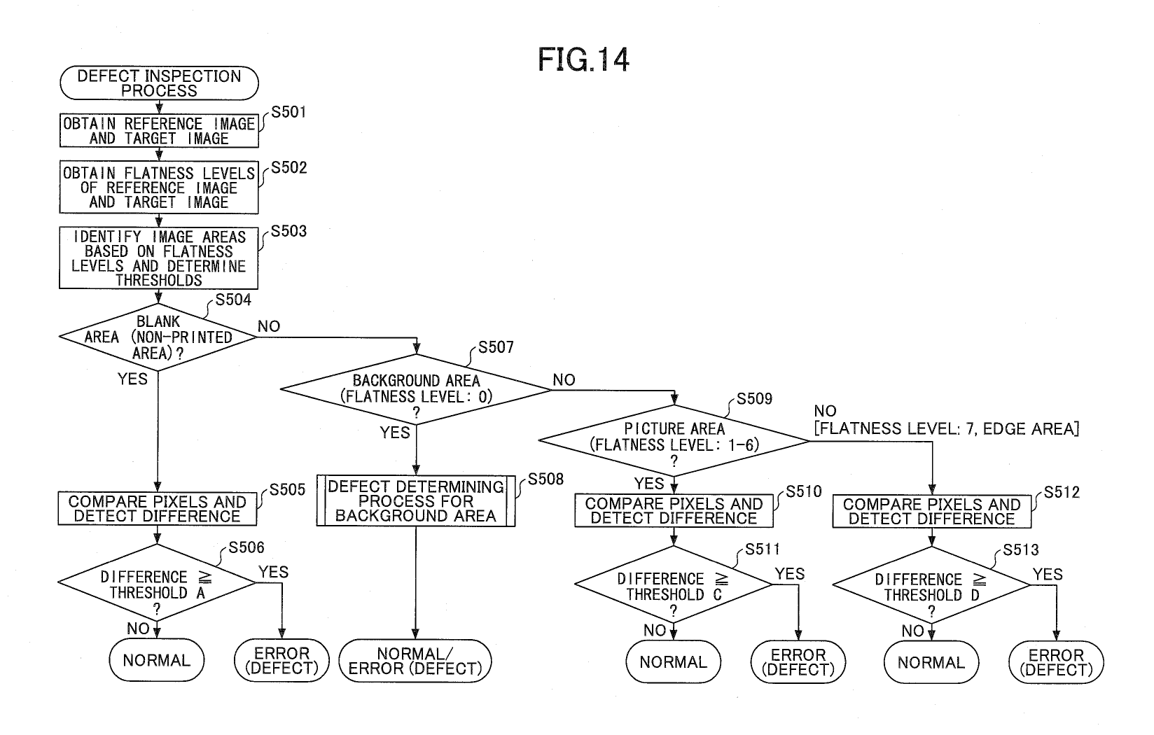

FIG. 14 is a flowchart illustrating an exemplary defect inspection process according to the second embodiment. Below, steps S502 and S508 of FIG. 14 that are different from the corresponding steps in FIG. 8 are mainly described.

As illustrated in FIG. 14, the image obtaining unit 11 of the inspection apparatus 100 obtains the reference image G1 and the target image G2 (step S501). Next, the flatness analysis unit 12 analyzes the reference image G1 and the target image G2 and thereby obtains their flatness levels (step S502). In this step, the flatness analysis unit 12 adjusts the coordinate spaces of the reference image G1 and the target image G2 to correlate the analysis results of the reference image G1 and the target image G2. The flatness analysis unit 12 sends the obtained analysis results (flatness levels) to the inspection control unit 13.

Next, the inspection control unit 13 controls the defect inspection process for respective types of image areas based on the flatness levels of the reference image G1.

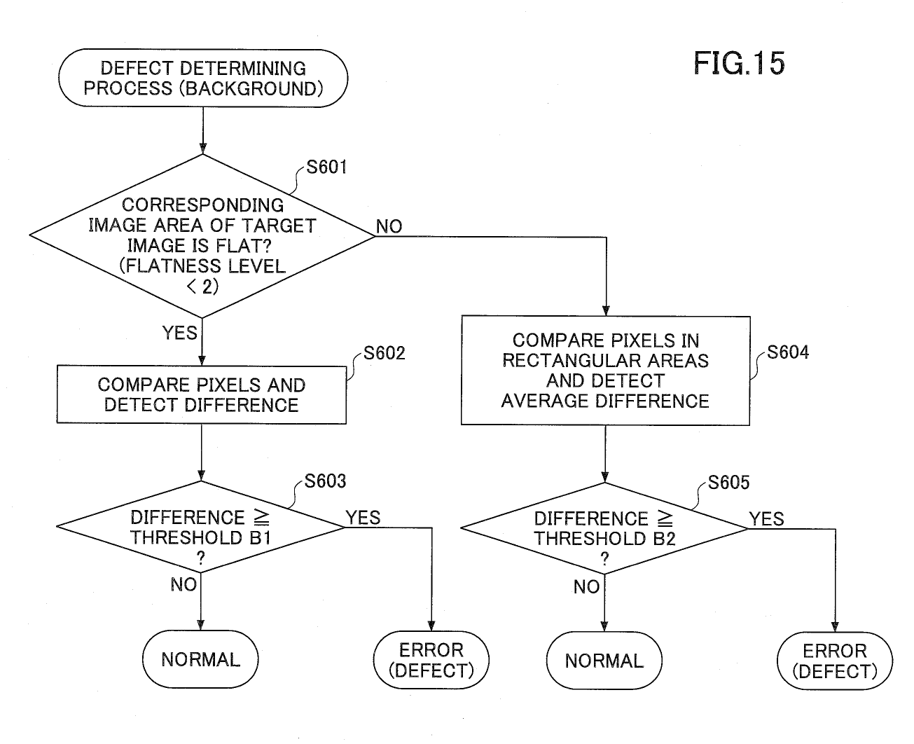

When the background area is identified in the reference image G1 (NO in step S504 and YES in step S507), the area identifying unit 131 performs a defect determining process as illustrated in FIG. 15 (step S508).

### <Defect Determining Process for Background Area>

FIG. 15 is a flowchart illustrating an exemplary defect determining process for a background area according to the second embodiment.

The area identifying unit 131 of the inspection control unit 13 determines whether an image area of the target image G2 corresponding to the background area of the reference image G1 is flat based on the obtained flatness levels (analysis results) of the target image G2 (step S601). In this step, the area identifying unit 131 refers to a flatness level(s) (in the obtained flatness levels) of the image area of the target image G2 and determines whether the flatness level is greater than or equal to a predetermined flatness threshold.

When the flatness level of the image area of the target image G2 is less than the flatness threshold (YES in step S601), the area identifying unit 131 assumes that there is no defect in the image area of the target image G2 and the difference detecting unit 132 detects differences between pixels in the reference image G1 and the target image G2 according to the first difference detection method (step S602).

Next, the determining unit 133 determines whether the differences detected by the difference detecting unit 132 are greater than or equal to an inspection threshold B1 (step S603). The inspection threshold B1 corresponds to the second inspection threshold (defect determining criterion) described above and is greater than an inspection threshold B2 that corresponds to the first inspection threshold and is used when the flatness level is greater than or equal to the flatness threshold.

If the differences are greater than or equal to the inspection threshold B1 (YES in step S603), the determining unit 133 determines that there is a defect (or an error) in the image area of the target image G2.

Meanwhile, when the flatness level of the image area of the target image G2 is greater than or equal to the flatness threshold (NO in step S601), the area identifying unit 131 assumes that there is a defect in the image area of the target image G2 and the difference detecting unit 132 detects average differences between pixels in rectangular areas R of the reference image G1 and the target image G2 according to the second difference detection method (step S604).

Next, the determining unit 133 determines whether the differences detected by the difference detecting unit 132 are greater than or equal to the inspection threshold B2 (step S605). The inspection threshold B2 (first inspection threshold) is set at a value less than the inspection threshold B1 so that small deviations in pixel values can be detected.

If the differences are greater than or equal to the inspection threshold B2 (YES in step S605), the determining unit 133 determines that there is a defect (or an error) in the image area of the target image G2.

### <Summary>

As described above, the image obtaining unit 11 of the inspection apparatus 100 obtains the reference image G1 and the target image G2. Next, the flatness analysis unit 12 analyzes the reference image G1 and the target image G2 to obtain flatness levels indicating degrees of variation in pixel values in the reference image G1 and the target image G2.

Based on the obtained flatness levels of the reference image G1, the inspection control unit 13 identifies various types of image areas in the reference image G1 and determines inspection thresholds (defect determining criteria) for the respective types of image areas.

When a flat area where the degree of variation in pixel values is small is identified in the reference image G1, the inspection control unit 13 refers to a flatness level(s) (in the obtained flatness levels) of an image area of the target image G2 that corresponds to the identified flat area of the reference image G1. Next, based on the flatness level, the inspection control unit 13 determines the probability that a defect is present in the image area of the target image G2 and if it is probable that a defect is present, determines a strict (or sensitive) threshold (defect determining criterion) for the image area of the target image G2.

Next, the inspection control unit 13 compares pixels in the flat area of the reference image G1 with pixels in the corresponding image area of the target image G2 to detect differences between their pixel values. Then, the inspection control unit 13 determines whether the detected differences are greater than or equal to the “strict” threshold to detect defects in the image area of the target image G2.

Accordingly, the inspection apparatus 100 of the second embodiment provides advantageous effects similar to those of the first embodiment and also makes it possible to efficiently inspect the print quality of a flat area where the degree of variation in pixel values is small.

The inspection functions of the above embodiments are implemented, for example, by executing a program(s), which is written in a programming language supported by the operating environment (platform) of the inspection apparatus 100 (the image processing apparatus 200 or the image forming apparatus 300), using a processing unit of the inspection apparatus 100 (the image processing apparatus 200 or the image forming apparatus 300).

For example, such a program may be stored in a non-transitory computer-readable storage medium (e.g., the storage medium 103a/214a/314a) such as a floppy (flexible) disk (FD), a compact disk (CD), a digital versatile disk (DVD), a secure digital (SD) memory card, and a universal serial bus (USB) memory. The program stored in the storage medium may be installed in the inspection apparatus 100 (the image processing apparatus 200 or the image forming apparatus 300) via the drive unit 103 (or the external storage I/F 214/314). Alternatively, the program may be installed via a telecommunication line and the interface unit 107 (or the network I/F 213/313) into the inspection apparatus 100 (the image processing apparatus 200 or the image forming apparatus 300).

In the above embodiments, the degrees of variation in pixel values are represented by eight flatness levels. However, any number of flatness levels may be used depending on the desired inspection accuracy.

Also in the above embodiments, printed areas including the background area, the picture area, and the edge area and a non-printed area including the blank area are identified based on the flatness levels. However, the types of image areas to be identified are not limited to those described above. Any number of types of image areas may be defined in association with flatness levels.

The inspection apparatus 100 may include an image processor(s) (e.g., an application specific integrated circuit (ASIC)) and multiple difference detection processes for different types of image areas may be executed in parallel. In this case, differences in pixel values detected for the respective types of image areas may be temporarily stored in a storage area and may be referred to in a defect determining process(es) to be performed later by a CPU.

In the second embodiment, both the reference image G1 and the target image G2 are analyzed to obtain flatness levels. Alternatively, the flatness levels of the target image G2 may be obtained only when a background area is detected based on the flatness levels of the reference image G1.

The present invention is not limited to the specifically disclosed embodiments, and variations and modifications may be made without departing from the scope of the present invention.

An aspect of this disclosure provides an inspection apparatus, an inspection method, and a non-transitory storage medium storing program code for causing the inspection apparatus to perform the inspection method.

What is claimed is:

1. An inspection apparatus, comprising:
an obtaining unit configured to receive a target image obtained by scanning a printed surface of a printed material and receive a reference image obtained from print data of the printed surface;
an analysis unit configured to analyze the reference image to obtain flatness levels indicating degrees of variation in pixel values; and
a control unit configured to
determine inspection thresholds for different types of image areas in the reference image based on the flatness levels,
compare the reference image and the target image to detect differences in pixel values, and
determine whether the differences are greater than or equal to the inspection thresholds to inspect print quality of the printed surface for the respective image areas.

2. The inspection apparatus as claimed in claim 1, wherein the control unit is configured to
identify the different types of the image areas in the reference image based on the flatness levels; and
assign preset values to the different types of the image areas as the inspection thresholds.

3. The inspection apparatus as claimed in claim 2, wherein
the image areas include printed areas where information is printed and non-printed areas where no information is printed;
a higher flatness level of the flatness levels indicates a lower degree of variation in pixel values and a lower flatness level of the flatness levels indicates a higher degree of variation in pixel values; and
the control unit is configured to
assign a smallest preset value of the preset values to one of the printed areas whose flatness level is highest among the printed areas, and
assign a largest preset value of the preset values to one of the printed areas whose flatness level is lowest among the printed areas.

4. The inspection apparatus as claimed in claim 2, wherein the control unit is configured to
compare pixels in the respective image areas of the reference image with pixels in corresponding image areas of the target image to detect the differences in pixel values; and
determine whether the differences are greater than or equal to the inspection thresholds assigned to the corresponding image areas to detect a defect in the printed surface.

5. The inspection apparatus as claimed in claim 4, wherein the control unit is configured to perform a first difference detection process where pixels in the reference image and pixels at corresponding positions in the target image are compared to obtain absolute values indicating the differences in pixel values between the pixels.

6. The inspection apparatus as claimed in claim 4, wherein the control unit is configured to perform a second difference detection process where pixels in a rectangular area of the reference image are compared with pixels in the corresponding rectangular area of the target image to obtain absolute values indicating the differences in pixel values, the absolute values are totaled to obtain a total difference, and the total difference is divided by a number of the pixels in the rectangular area to obtain an average difference in the rectangular area.

7. The inspection apparatus as claimed in claim 4,
wherein the control unit is configured to determine whether to perform a first difference detection process or a second difference detection process based on the types of the image areas;
wherein in the first difference detection process, pixels in the reference image and pixels at corresponding positions in the target image are compared to obtain absolute values indicating the differences in pixel values between the pixels;
wherein in the second difference detection process, pixels in a rectangular area of the reference image are compared with pixels in the corresponding rectangular area of the target image to obtain absolute values indicating the differences in pixel values, the absolute values are totaled to obtain a total difference, and the total difference is divided by a number of the pixels in the rectangular area to obtain an average difference in the rectangular area.

8. The inspection apparatus as claimed in claim 7, wherein
a higher flatness level of the flatness levels indicates a lower degree of variation in pixel values and a lower flatness level of the flatness levels indicates a higher degree of variation in pixel values; and
the control unit is configured to
perform the second difference detection process for the image areas whose flatness levels are higher than a predetermined level; and
perform the first difference detection process for the image areas whose flatness levels are lower than or equal to the predetermined level.

9. The inspection apparatus as claimed in claim 1, wherein
the analysis unit is configured to analyze the target image in addition to the reference image to obtain flatness levels; and
when a flat image area whose flatness level is higher than a predetermined level is identified in the reference image based on the flatness levels of the reference image, the control unit is configured to
determine whether a value indicating the flatness level of an area of the target image corresponding to the flat image area is greater than or equal to a predetermined flatness threshold, and
select the inspection threshold for the flat image area based on the determination result.

10. The inspection apparatus as claimed in claim 9, wherein
the control unit is configured to
select a first value as the inspection threshold for the flat image area when the value indicating the flatness level of the area of the target image is greater than or equal to the predetermined flatness threshold, and
select a second value as the inspection threshold for the flat image area when the value indicating the flatness level of the area of the target image is less than the predetermined flatness threshold, the first value being less than the second value.

11. The inspection apparatus as claimed in claim 9,
wherein the control unit is configured to
perform a first difference detection process for the flat image area when the value indicating the flatness level of the area of the target image is less than the predetermined flatness threshold, and
perform a second difference detection process for the flat image area when the value indicating the flatness level of the area of the target image is greater than or equal to the predetermined flatness threshold;
wherein in the first difference detection process, pixels in the reference image and pixels at corresponding positions in the target image are compared to obtain absolute values indicating the differences in pixel values between the pixels;
wherein in the second difference detection process, pixels in a rectangular area of the reference image are compared with pixels in the corresponding rectangular area of the target image to obtain absolute values indicating the differences in pixel values, the absolute values are totaled to obtain a total difference, and the total difference is divided by a number of the pixels in the rectangular area to obtain an average difference in the rectangular area.

12. The inspection apparatus as claimed in claim 1, wherein the analysis unit is configured to obtain the flatness levels by calculating a standard deviation or a variance of pixel values in each rectangular area of the reference image.

13. The inspection apparatus as claimed in claim 1, wherein the analysis unit is configured to obtain the flatness levels by calculating a total or an average of differences between pixel values of a reference pixel and adjacent pixels adjacent to the reference pixel in each rectangular area of the reference image.

14. A method performed by an inspection apparatus for inspecting print quality of a printed surface of a printed material, the method comprising:
receiving a target image obtained by scanning the printed surface and a reference image obtained from print data of the printed surface;
analyzing the reference image to obtain flatness levels indicating degrees of variation in pixel values;
determining inspection thresholds for different types of image areas in the reference image based on the flatness levels;
comparing the reference image and the target image to detect differences in pixel values; and
determining whether the differences are greater than or equal to the inspection thresholds to inspect the print quality of the printed surface for the respective image areas.

15. A non-transitory computer-readable storage medium storing program code for causing a computer to perform a method for inspecting print quality of a printed surface of a printed material, the method comprising:
receiving a target image obtained by scanning the printed surface and a reference image obtained from print data of the printed surface;
analyzing the reference image to obtain flatness levels indicating degrees of variation in pixel values;
determining inspection thresholds for different types of image areas in the reference image based on the flatness levels;
comparing the reference image and the target image to detect differences in pixel values; and
determining whether the differences are greater than or equal to the inspection thresholds to inspect the print quality of the printed surface for the respective image areas.
